(19) United States
(12) Patent Application Publication
(10) Pub. No.: US 2018/0152491 A1
(43) Pub. Date: May 31, 2018

(54) IMAGE PROVISION APPARATUS AND IMAGE RECEPTION APPARATUS, CONTROL METHOD THEREOF, IMAGE COMMUNICATION SYSTEM, AND COMPUTER-READABLE STORAGE MEDIUM

(71) Applicant: CANON KABUSHIKI KAISHA, Tokyo (JP)

(72) Inventor: Kenichiroh Hara, Yokohama-shi (JP)

(21) Appl. No.: 15/817,480

(22) Filed: Nov. 20, 2017

(30) Foreign Application Priority Data
Nov. 25, 2016 (JP) 2016-229188

(51) Int. Cl. H04L 29/06; H04N 1/00; H04N 1/333

(52) U.S. Cl. CPC H04L 65/4069; H04N 1/00106; H04N 2201/0084; H04L 65/1059; H04N 1/33346

(57) ABSTRACT

An image provision apparatus transmits image data to an image reception apparatus in response to a request for image data in compliance with a first protocol received from the image reception apparatus. Also, the image provision apparatus, upon receiving a request for information relating to streaming of image data in compliance with the first protocol from the image reception apparatus, transmits information relating to streaming to the external device. Furthermore, the image provision apparatus, in response to a request for streaming based on information relating to streaming in compliance with a second protocol received from the image reception apparatus, streams image data to an image reception apparatus. The image reception apparatus performs a request for streaming, reception of moving image data, and playback in compliance with the second protocol using a function of an OS, for example.

### BACKGROUND OF THE INVENTION

### Field of the Invention

The present invention relates to, in general, image provision apparatuses and image reception apparatuses, control methods thereof, image communication systems, and a computer-readable storage medium.

### Description of the Related Art

Heretofore, in the case where image data (still image data and moving image data) of an image provision apparatus (image capture apparatus, for example) is transferred to an image reception apparatus (a smartphone or PC, for example), communication based on PTP (Picture Transfer Protocol) is used (Japanese Patent Laid-Open No. 2007-148802).

An image transfer application that runs on the image reception apparatus, in general, obtains thumbnail images of the image data that the image provision apparatus has, displays the obtained thumbnail images as a list, obtains the image data corresponding to the selected thumbnail image from the image provision apparatus, and stores and/or displays the obtained image data.

In the case where moving image data is transferred from the image provision apparatus to the image reception apparatus, if a function of performing streaming playback, without waiting for the transfer to complete, is provided, the usability is improved. However, in the case of implementing the function of realizing streaming playback in an image transfer application that runs on the image reception apparatus, the load to develop the image transfer application is large. In particular, in the case where the operating environment of the image transfer application such as basic software (OS) that runs on the image reception apparatus is not equipped with a mechanism for basic streaming playback, the development load further increases.

### SUMMARY OF THE INVENTION

The present invention has been made in view of the problem of the conventional technique as described above, and provides a technique with which the load to develop an image transfer application that operates on an image reception apparatus that receives moving image data is reduced.

According to an aspect of the present invention, there is provided an image provision apparatus comprising: a communication interface; and a processor that controls communication with an external device via the communication interface, wherein the processor: transmits, in response to a request for image data that is received from an external device, the image data to the external device, the request for the image data being in compliance with a first protocol, transmits, in response to a request for information relating to streaming of the image data that is received from the external device, the information relating to streaming to the external device, the request for the information relating to streaming of the image data being in compliance with the first protocol, and performs, in response to a request for streaming based on the transmitted information relating to streaming that is received from the external device, streaming of the image data to the external device, the request for the streaming being in compliance with a second protocol.

According to another aspect of the present invention, there is provided an image reception apparatus comprising: a communication interface; and a processor that controls communication with an external device via the communication interface, wherein the processor: obtains information relating to image files that an external device has from the external device through communication with the external device, the communication being in compliance with a first protocol, obtains, in compliance with the first protocol, information relating to streaming of a moving image file, among the image files, from the external device, transmits a request for streaming with respect to the moving image file based on the obtained information relating to streaming to the external device in compliance with a second protocol, using a function provided by an operating system running on the image reception apparatus, and performs playback on image data from the external device that is received in compliance with the second protocol, using a function provided by the operating system.

According to a further aspect of the present invention, there is provided an image communication system comprising: an image provision apparatus; and an image reception apparatus, wherein the image provision apparatus and the image reception apparatus are connected in a communicable manner, wherein the image provision apparatus comprises: a first communication interface; and a first processor that controls communication with an external device via the first communication interface, wherein the first processor: transmits, in response to a request for image data that is received from an image reception apparatus, the image data to the image reception apparatus, the request for the image data being in compliance with a first protocol, transmits, in response to a request for information relating to streaming of the image data that is received from the image reception apparatus, the information relating to streaming to the image reception apparatus, the request for the information relating to streaming of the image data being in compliance with the first protocol, and performs, in response to a request for streaming based on the transmitted information relating to streaming that is received from the image reception apparatus, streaming of the image data to the image reception apparatus, the request for the streaming being in compliance with a second protocol, and wherein the image reception apparatus comprises: a second communication interface; and a second processor that controls communication with an external device via the second communication interface, wherein the second processor: obtains information relating to image files that an image provision apparatus has from the image provision apparatus through communication with the image provision apparatus, the communication being in compliance with a first protocol, obtains, in compliance with the first protocol, information relating to streaming of a moving image file, among the image files, from the image provision apparatus, transmits a request for streaming with respect to the moving image file based on the obtained information relating to streaming to the image provision apparatus in compliance with a second protocol, using a function provided by an operating system running on the image reception apparatus, and performs playback on image data from the image provision apparatus that is received in compliance with the second protocol, using a function provided by the operating system.

According to another aspect of the present invention, there is provided a control method of an image provision apparatus, comprising: transmitting, in response to a request for image data that is received from an external device, the image data to the external device, the request for the image data being in compliance with a first protocol, transmitting, in response to a request for information relating to streaming of the image data that is received from the external device, the information relating to streaming to the external device, the request for the information relating to streaming of the image data being in compliance with the first protocol, and performing, in response to a request for streaming based on the transmitted information relating to streaming that is received from the external device, streaming of the image data to the external device, the request for the streaming being in compliance with a second protocol.

According to a further aspect of the present invention, there is provided a control method of an image reception apparatus comprising: obtaining information relating to image files that an external device has from the external device through communication with the external device, the communication being in compliance with a first protocol, obtaining, in compliance with the first protocol, information relating to streaming of a moving image file, among the image files, from the external device, transmitting a request for streaming with respect to the moving image file based on the obtained information relating to streaming to the external device in compliance with a second protocol using a function provided by an operating system running on the image reception apparatus, and performing playback on image data from the external device that is received in compliance with the second protocol, using a function provided by the operating system.

According to another aspect of the present invention, there is provided a non-transitory computer-readable storage medium that stores a program for causing a computer to function as an image provision apparatus that comprises: a communication interface; and a processor that controls communication with an external device via the communication interface, wherein the processor: transmits, in response to a request for image data that is received from an external device, the image data to the external device, the request for the image data being in compliance with a first protocol, transmits, in response to a request for information relating to streaming of the image data that is received from the external device, the information relating to streaming to the external device, the request for the information relating to streaming of the image data being in compliance with the first protocol, and performs, in response to a request for streaming based on the transmitted information relating to streaming that is received from the external device, streaming of the image data to the external device, the request for the streaming being in compliance with a second protocol.

According to a further aspect of the present invention, there is provided a non-transitory computer-readable storage medium that stores a program for causing a computer to function as an image reception apparatus that comprises: a communication interface; and a processor that controls communication with an external device via the communication interface, wherein the processor: obtains information relating to image files that an external device has from the external device through communication with the external device, the communication being in compliance with a first protocol, obtains, in compliance with the first protocol, information relating to streaming of a moving image file, among the image files, from the external device, transmits a request for streaming with respect to the moving image file based on the obtained information relating to streaming to the external device in compliance with a second protocol, using a function provided by an operating system running on the image reception apparatus, and performs playback on image data from the external device that is received in compliance with the second protocol, using a function provided by the operating system.

Further features of the present invention will become apparent from the following description of exemplary embodiments with reference to the attached drawings.

### BRIEF DESCRIPTION OF THE DRAWINGS

FIG. 1 is a schematic diagram of an image communication system according to an embodiment of the present invention.

FIGS. 2A to 2C are diagrams illustrating an exemplary functional configuration and an exemplary external appearance of a digital camera 100 according to the embodiment.

FIG. 3 is a block diagram illustrating an exemplary functional configuration of a smartphone 200 according to the embodiment.

FIG. 4 is a sequence diagram of streaming playback in the case where only PTP communication is used.

FIG. 5 is a sequence diagram of streaming playback in the embodiment.

FIGS. 6A and 6B are flowcharts illustrating operations of the digital camera 100 in the embodiment.

FIGS. 7A and 7B are flowcharts illustrating operations of the smartphone 200 in the embodiment.

FIGS. 8A to 8F and FIG. 9 are schematic diagrams illustrating exemplary transitions and exemplary displays of the screen of the smartphone 200 in the embodiment.

### DESCRIPTION OF THE EMBODIMENTS

Exemplary embodiments of the present invention will now be described in detail in accordance with the accompanying drawings. Note that, in the following embodiment, a communication system constituted by a digital camera serving as an example of an image provision apparatus according to the present invention and a smartphone serving as an example of an image reception apparatus that can communicate with the digital camera will be described. Note that the image provision apparatus and the image reception apparatus are not limited to the digital camera and the smartphone, and may be any electronic devices that can communicate with each other. These electronic devices include a personal computer, a tablet computer, a media player, a PDA, a game machine, a smart watch, a printer, a remote controller, and the like, but are not limited thereto.

### First Embodiment

### System Configuration Diagram

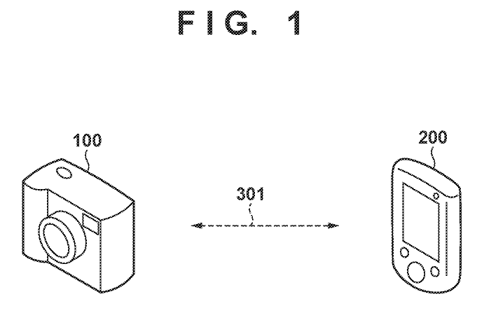

FIG. 1 is a diagram schematically illustrating the configuration of an image communication system according to an embodiment of the present invention. The image communication system includes a digital camera 100 and a smartphone 200. The digital camera 100 and the smartphone 200 can communicate using a wireless connection 301. Here, the wireless connection 301 complies with a so-called wireless LAN standard of the IEEE 802.11 series. Note that the wireless connection 301 may be in an ad hoc mode or in an infrastructure mode, and in the latter case, the digital camera 100 and the smartphone 200 communicate via an access point. Also, the wireless connection 301 may comply with another standard, and the digital camera 100 and the smartphone 200 may be connected by wire.

Configuration of Digital Camera

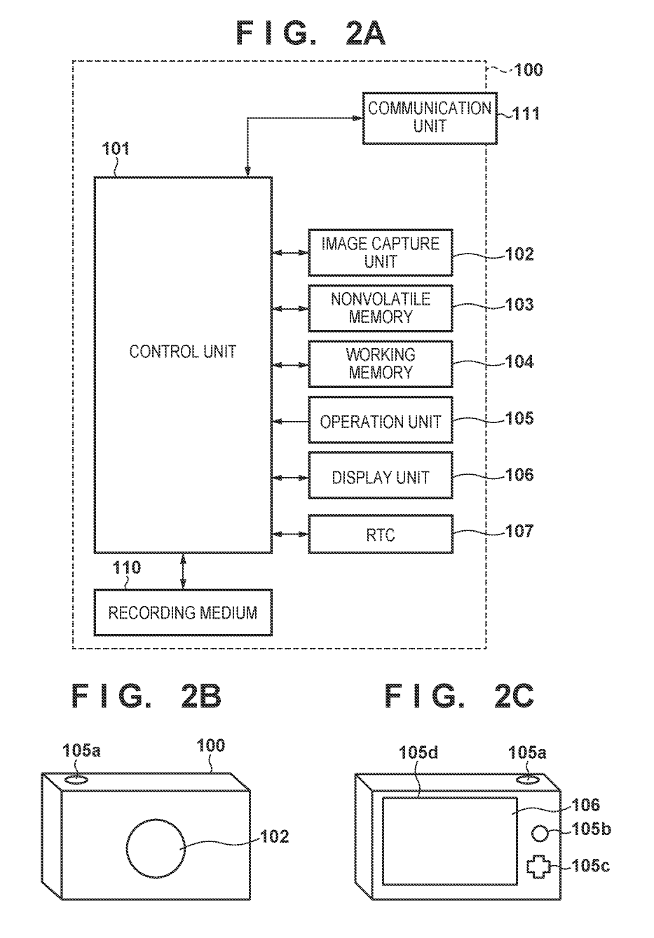

FIG. 2A is a block diagram illustrating an exemplary functional configuration of the digital camera 100.

A control unit 101 includes, for example, at least one programmable processor (hereinafter referred to as MPU for the sake of convenience). The control unit 101 implements various functions of the digital camera 100 including a function of communicating with an external device by causing the MPU to execute a program stored in a nonvolatile memory 103 so as to control the constituent elements. The digital camera 100 is not necessarily controlled intensively by the control unit 101, and may be controlled in a distributed manner in cooperation with a processor included in another functional block.

An image capture unit 102 includes, for example, a lens unit including a zoom lens, a focus lens, and a diaphragm, a controller (for example, MPU) that controls the operations of the lens unit, an image sensor, and the like. The image sensor is a photoelectric conversion device that converts an optical image formed by the lens unit to a group of electric signals (pixel signals), and in general, a CMOS (complementary metal oxide semiconductor) or a CCD (charge coupled device) image sensor is used. The image capture unit 102 also includes a signal processing circuit for executing A/D conversion, noise reduction processing, and the like, and outputs a group of digital pixel signals (image data). The image data is processed in the same manner as in a commonly used digital camera, and is recorded in a recording medium 110 such as, for example, a memory card, in an image data file format, displayed in a display unit 106, or output to an external device. Note that the digital camera 100 records the image data to the recording medium 110 in compliance with the DCF (Design Rule for Camera File System) standard.

The nonvolatile memory 103 is, for example, an electrically erasable and recordable memory, and stores therein a program executed by the control unit 101, GUI data, various types of setting values, registration information (identification information, an encryption key for communication, and the like) of an external device, and the like.

A working memory 104 is used as a buffer memory for temporarily storing image data captured by the image capture unit 102, a display memory (VRAM) for the display unit 106, a work area used when the control unit 101 executes a program, and the like.

An operation unit 105 is a group of input devices for the user to input an instruction to the digital camera 100. The operation unit 105 includes, for example, a power button for providing an instruction to turn on or off the digital camera 100, a release switch for providing an instruction to start preparing for image capture and an instruction to start image capture, and a playback button for providing an instruction to play back (display) image data. The operation unit 105 may include a connection button for starting communication with an external device via a communication unit 111.

Note that, the release switch includes two switches, namely a switch SW1 that is turned on when it is pressed halfway and a switch SW2 that is turned on when it is pressed all the way. When the switch SW1 is turned on, an instruction to start preparing for image capture is provided, and when the switch SW2 is turned on, an instruction to start image capture is provided. Upon detection of an instruction to start preparing for image capture, the control unit 101 starts preparation for image capture such as AF (auto focus) processing, AE (auto exposure) processing, AWB (auto white balance) processing, and EF (flash pre-emission) processing. Upon detecting an instruction to start image capture, the control unit 101 starts image capture processing for recording by using the results of processing operations carried out in the preparation for image capture.

The display unit 106 displays a live view image, a recorded image, as well as displaying a screen for interactive operation. The display unit 106 may be an external display apparatus provided outside the digital camera 100. In the case where the display unit 106 is a touch display, a touch panel provided in the display unit 106 is included in the operation unit 105.

An RTC (real time clock) 107 is an internal clock, and manages the date and time. The date and time may be set by a user, or may be automatically set by obtaining the date and time from an external device such as an NTP server via the communication unit 111, or by receiving a radio wave such as a GPS signal.

The recording medium 110 is, for example, a semiconductor memory, and may be or may not be detachable from the digital camera 100. An image file based on the image data output from the image capture unit 102 is recorded in the recording medium 110.

The communication unit 111 is a communication interface between the digital camera 100 and an external device, and is a so-called wireless LAN interface in compliance with IEEE 802.11x in the present embodiment. Accordingly, the communication unit 111 includes an antenna, a modulation demodulation circuit, and a communication controller, for example. Note that it is sufficient that the communication unit 111 complies with any one or more wireless communication standards, and the communication unit 111 may comply with another wireless communication method such as near-field communication, short-range wireless communication, infrared communication, or the like. The digital camera 100 can transmit image data obtained by the image capture unit 102 and image data recorded in the recording medium 110 to an external device via the communication unit 111. Note that, the communication between the communication unit 111 and the external device performed by the communication unit 111 is executed under the control of the control unit 101. Note that the communication unit 111 may be a wireless communication interface that complies with another standard, or may instead or further include a wired communication interface.

The digital camera 100 can communicate with an external device in an ad hoc mode or an infrastructure mode. In the case of performing communication in the infrastructure mode, the digital camera 100 can participate, by being connected to an access point (AP) in the vicinity thereof as a slave apparatus, in a network formed by the AP. Also, the digital camera 100 can also operate as a simplified AP having a limited function, and apparatuses in the vicinity of the digital camera 100 recognize the digital camera 100 as an AP and can participate in the network formed by the digital camera 100. Note that a simplified AP does not have a gateway function of transferring data received from a slave apparatus to an internet provider or the like. Accordingly, the digital camera 100 that operates as a simplified AP cannot transfer data received from another apparatus that is participating in the network formed by the digital camera 100 to another network. The control unit 101 causes the digital camera 100 to operate in the ad hoc mode or the infrastructure mode by executing a program stored in the nonvolatile memory 103. Note that whether the digital camera 100 operates in the ad hoc mode or operates as a slave apparatus or a simplified AP in the infrastructure mode is set in advance.

FIGS. 2B and 2C are perspective views schematically illustrating an exemplary external appearance of the digital camera 100. The release switch 105a, the playback button 105b, a direction keypad 105c, and a touch panel 105d are examples of the operation members included in the operation unit 105.

Configuration of Smartphone

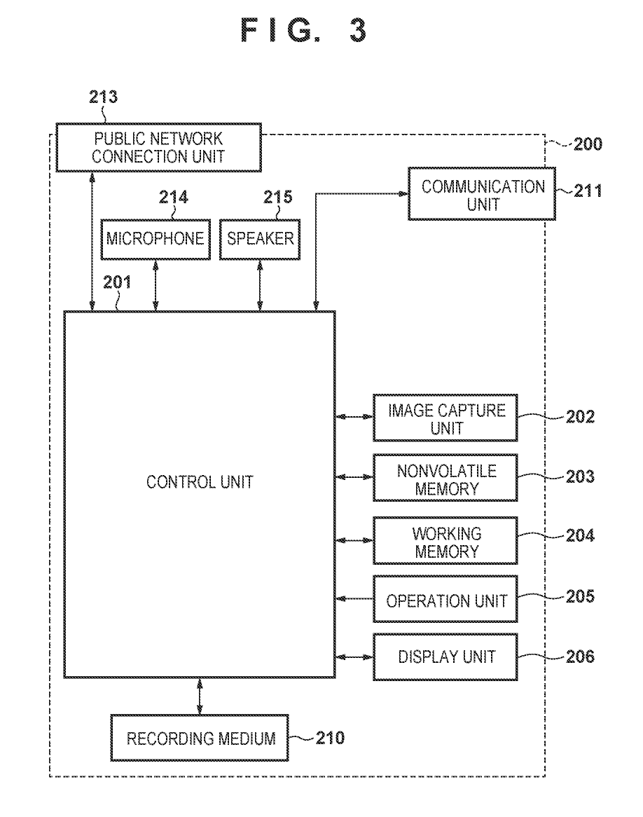

FIG. 3 is a block diagram showing an exemplary functional configuration of the smartphone 200 that is an example of an external device that communicates with the digital camera 100.

A control unit 201 includes, for example, at least one programmable processor (hereinafter referred to as MPU for the sake of convenience). The control unit 201 realizes various functions of the smartphone 200 including a function of performing communication with an external device such as the digital camera 100 by causing the MPU to execute a program stored in a nonvolatile memory 203 so as to control the constituent elements. The smartphone 200 is not necessarily controlled intensively by the control unit 201, and may be controlled in a distributed manner in cooperation with a processor included in another functional block.

An image capture unit 202 includes, for example, a lens unit including a focus lens and a diaphragm, a controller (for example, MPU) that controls the operations of the lens unit, an image sensor, and the like. The image capture unit 202 also includes a signal processing circuit for executing A/D conversion, noise reduction processing, and the like, and outputs a group of digital pixel signals (image data). The image data is processed by the control unit 201 in the same manner as in a commonly used digital camera, and is recorded in a recording medium 210 such as, for example, a memory card, in an image data file format, displayed on a display unit 206, or output to an external device.

The nonvolatile memory 203 stores programs executed in the control unit 201 (OS (operating system), an application program (hereinafter referred to as application) that runs on the OS, and the like). The nonvolatile memory 203 also stores GUI data, various types of setting values, information (identification information, an encryption key for communication, and the like) regarding an external device that has been registered as a communication partner, and the like. In the present embodiment, the communication between the smartphone 200 and the digital camera 100 is realized through an image transfer application installed in the nonvolatile memory 203. Note that the image transfer application is assumed to include a program for using functions of the OS. Note that the OS may include a program for realizing the processing relating to the present embodiment.

A work memory 204 is used as a display memory (VRAM) for the display unit 206, a work area used when the control unit 201 executes the OS or the application, and the like.

An operation unit 205 is a group of input devices for a user to input an instruction to the smartphone 200. The operation unit 205 includes, for example, a power button for providing an instruction to turn on or off the smartphone 200, a touch panel that is included in the display unit 206, and the like. In addition, the operation unit 205 may include a volume adjustment button, a shutter button, and the like. Note that the operation unit 205 may include an input device for authentication such as, for example, an iris sensor or a fingerprint sensor.

The display unit 206 is a touch display, and displays a GUI screen provided by the OS as well as displaying various types of information provided by various types of applications.

An RTC (real time clock) 207 is an internal clock, and manages the date and time. The date and time may be set by a user, or may be automatically set by obtaining the date and time from an external device such as an NTP server via the communication unit 211, or by receiving a radio wave such as a GPS signal.

The recording medium 210 is, for example, a semiconductor memory, and may be or may not be detachable from the smartphone 200. In the recording medium 210, data used by the applications, still image and moving image data captured by the image capture portion 202, data received from an external device, and the like can be recorded.

The communication unit 211 is a communication interface between the smartphone 200 and an external device, and is a so-called wireless LAN interface that is in compliance with IEEE 802.11x in the present embodiment. Accordingly, the communication unit 211 includes an antenna, a modulation demodulation circuit, a communication controller, for example. Note that it is sufficient that the communication unit 211 complies with any one or more wireless communication standards, and the communication unit 211 may comply with another wireless communication method such as near-field communication, short-range wireless communication, infrared communication, or the like. The smartphone 200 can transmit image data obtained by the image capture unit 202 and image data recorded in the recording medium 210 to an external device via the communication unit 211. Note that, the communication between the communication unit 211 and the external device performed by the communication unit 211 is executed under the control of the control unit 201. Note that the communication unit 211 may be a wireless communication interface that is in compliance with another standard, or may instead or further include a wired communication interface. Note that the smartphone 200 in the present embodiment can at least operate as a slave apparatus in the infrastructure mode, and can participate in the network that an AP in the vicinity thereof forms.

The smartphone 200 can communicate with an external device in the ad hoc mode or the infrastructure mode. In the case of performing communication in the infrastructure mode, the smartphone 200 is connected to an access point (AP) in the vicinity thereof as a slave apparatus, and as a result, the smartphone 200 can participate in the network formed by the AP. The control unit 201 causes the smartphone 200 to operate in the ad hoc mode or the infrastructure mode by executing a program stored in the nonvolatile memory 203. Note that whether the smartphone 200 operates in the ad hoc mode or operates in the infrastructure mode is set in advance.

The public network connection unit 213 is a communication interface for establishing a connection with a public wireless communication network. The public network connection unit 213 may comply with one or more standards including 3G, 4G, and the like. The smartphone 200 provides a function of performing a telephone call with a device on a public network via the public network connection unit 213. During a telephone call, the control unit 201 outputs audio that is input from a microphone 214 to the public network connection unit 213, and outputs an audio signal received from the public network connection unit 213 from a speaker 215. Note that the communication unit 211 and the public network connection unit 213 may share one antenna.

Outline of Operation

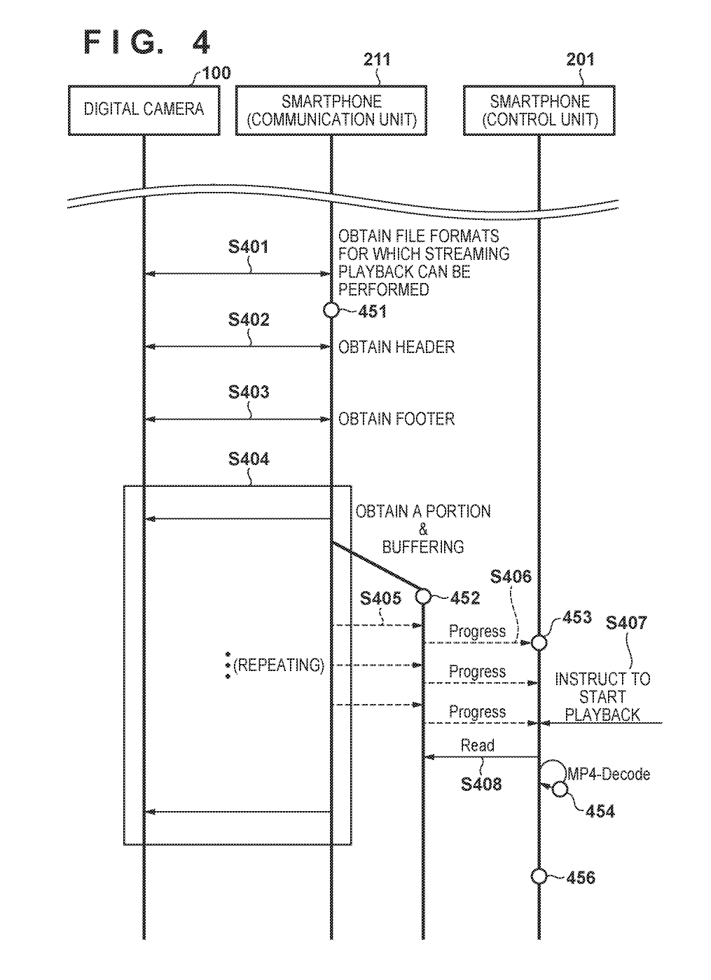

Before the operation of the embodiment is described, the operation of the smartphone 200 for performing streaming playback of moving image data stored in the digital camera 100 using PTP serving as a first protocol will be described using a sequence diagram in FIG. 4. Note that, in the present specification, “streaming playback” refers to playback that is started before the moving image data has been completely downloaded, and includes not only real time streaming playback, but also progressive download (pseudo-streaming playback).

Here, it is assumed that the wireless LAN connection has been established between the digital camera 100 (communication unit 111) and the smartphone 200 (communication unit 211), and the streaming playback of moving image data in the mp4 format that is stored in the digital camera 100 is realized only through the PTP communication. Note that, in the following description, the operation of the control unit 201 is realized by the control unit 201 of the smartphone 200 executing an application stored in the nonvolatile memory 203. Also, it is assumed that the PTP communication session is established on the wireless LAN connection.

In step S401, the control unit 201 of the smartphone 200 obtains a list of the file formats (file extension, for example) for which streaming can be performed from the digital camera 100 via the communication unit 211, and stores the list in the work memory 204. The control unit 201 further obtains a list of (a portion of or all of) image files stored in the digital camera 100, and displays the list in the display unit 206 in a selectable manner. Note that each of the image files is assigned with an identifier called an object handle for uniquely specifying the image file as a specification of PTP. When the control unit 201 of the smartphone 200 requests transmission of a file or the like to the digital camera 100, the control unit 201 notifies the digital camera 100 of the object handle of the target file along with the corresponding command.

At sequence point 451, the control unit 201 determines the order of obtaining data according to the file type of the moving image data on which streaming playback is performed. Note that the moving image data on which playback is performed may be designated by a user from the list of the image files that is displayed in the display unit 206 via the operation unit 205.

In step S402, the control unit 201, in order to perform streaming playback in the smartphone 200, obtains header data in accordance with the obtaining order determined at sequence point 451 from the digital camera 100 via the communication unit 211.

In step S403, the control unit 201 obtains footer data via the communication unit 211.

Step S404 schematically illustrates that the control unit 201 repeatedly transmits requests to the digital camera 100 via the communication unit 211 in order to repeatedly receive moving image data on which streaming playback is performed.

At sequence point 452, the control unit 201 secures a buffer having a capacity that corresponds to the size of the moving image data on which playback is to be performed, in a partial region of the work memory 204.

In step S405, the control unit 201 sequentially stores received data in the buffer while displaying the obtaining status of the moving image data in the display unit 206 using a UI such as a progress bar, for example. Note that the control unit 201 stores information relating to the obtaining status in the work memory 204 as well.

In step S406, the control unit 201 displays the length of a period during which playback can be performed in the display unit 206 from the amount of data stored in the buffer. This operation is repeatedly performed according to changes in the buffer.

From sequence point 453, the control unit 201 monitors the amount of data stored in the buffer, and repeatedly performs determination as to whether the streaming playback can be started or not. The control unit 201 determines that the streaming playback can be started if a condition (predetermined buffer occupancy rate, for example) according to the capacity of the entire buffer and the size (number of pixels) per one frame of the moving image data is satisfied, and enables the UI for receiving instruction to start playback, for example.

In step S407, an instruction to start playback is input to the control unit 201 via the operation unit 205, for example. If it is determined that the streaming playback is possible at this point, the control unit 201 reads out moving image data from the buffer in step S408. On the other hand, if it is not determined that the streaming playback is possible, the control unit 201 ignores the instruction to start playback, for example.

At sequence point 454, the control unit 201 starts decoding the moving image data read out from the buffer and displaying the moving image in the display unit 206. Thereafter, the control unit 201 repeats reading out in step S408 and decoding and displaying at sequence point 454.

Note that when an instruction such as stop playback, fast forward, or rewind is input via the UI displayed in the display unit 206 during the streaming playback, the control unit 201 executes the necessary processing. Also, the control unit 201 updates the progress bar display according to the progress or rewinding of the playback during the streaming playback.

The sequence of the streaming playback using PTP has been described above. In this way, the streaming playback can be realized using PTP. However, PTP is not supported by a general OS or application (web browser, for example). Therefore, operations for realizing the streaming playback in an OS or the like in which streaming data is not supported, specifically, the operations of the control unit 201 at the respective sequence points described above need to be implemented on a PTP communication application that runs on the smartphone 200. Therefore, the load to develop the PTP communication application is larger than that when streaming playback can be performed using the functions that are supported by a general OS and web browser such as HTTP (Hypertext Transfer Protocol) streaming, for example. Note that, here, HTTP (including HTTPS) serving as a second protocol is an example of the general-purpose streaming protocol with which an OS or the like supports streaming of moving image data.

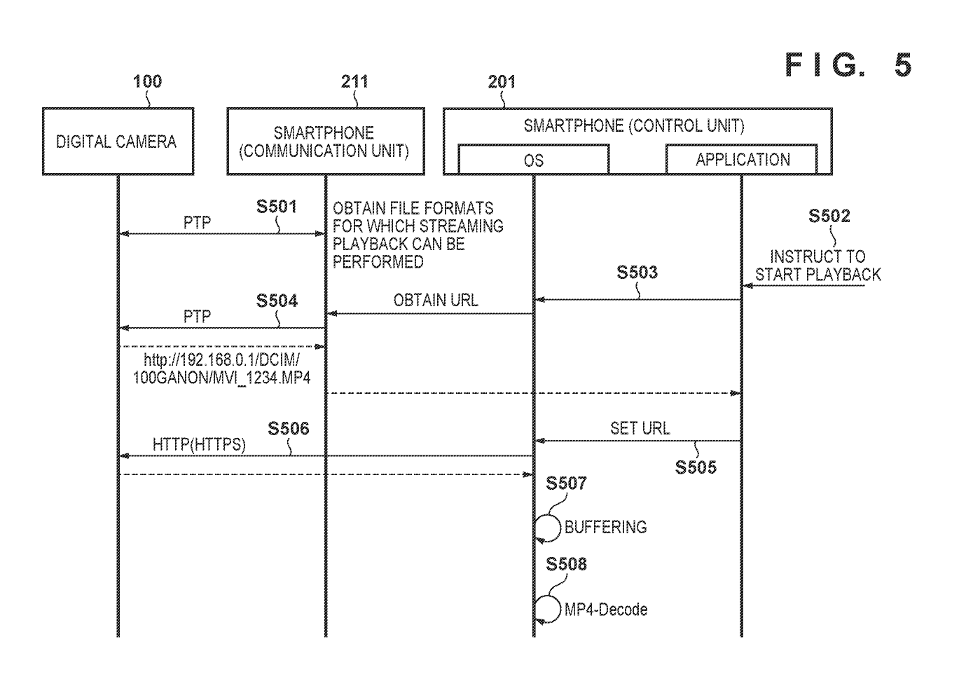

Therefore, in the present embodiment, as a result of performing streaming playback using a function (streaming function in HTTP) that the OS running on the smartphone 200 supports, from the PTP communication application, the load to develop the PTP communication application is reduced. Specific operations will be described using FIGS. 5 to 8F.

The sequence diagram shown in FIG. 5 shows the outline of operations of the digital camera 100 and the smartphone 200 when streaming playback of moving image data stored in the digital camera 100 is performed in the smartphone 200 using the method according to the present embodiment. The digital camera 100 includes the function of a streaming server (including HTTP server).

In step S501, the control unit 201 obtains a list of the file formats for which streaming can be performed from the digital camera 100 via the communication unit 211 using the PTP communication, and stores the list in the work memory 204. The control unit 201 further obtains a list of (a portion of or all of) image files stored in the digital camera 100, and displays the list in the display unit 206 in a selectable manner. This operation is similar to that in step S401.

In step S502, the control unit 201 (PTP communication application) receives an instruction to start performing streaming playback with respect to a moving image file selected from the list of image files that is being displayed in the display unit 206 via the operation unit 205.

In steps S503 and S504, the control unit 201 (PTP communication application) transmits a request for obtaining the streaming information relating to the streaming of the moving image file to which the start of playback was instructed to the digital camera 100 using the PTP communication via the communication unit 211. Note that this request is associated with the object handle of the moving image file to which the start of playback was instructed. Examples of the streaming information include information for causing the digital camera 100 to perform streaming such as a specific URL (Uniform Resource Locator) and a playlist in which segments of the moving image that is to be streamed are enumerated. The request for obtaining the information for specifying the moving image file and the operation for responding thereto are introduced as extensions of PTP. The control unit 201 stores the URL obtained from the digital camera 100 in the work memory 204.

In step S505, the control unit 201 (PTP communication application) delivers the obtained information to the OS in order to use the streaming playback function that the OS of the smartphone 200 includes.

In step S506, the control unit 201 transmits a request for streaming to the streaming server (HTTP server, here) of the digital camera 100 based on the URL delivered to the OS using the function of an HTTP client implemented in the OS. The digital camera 100 transmits the streaming data in response thereto.

In step S507, the control unit 201 (OS) starts storing the received streaming data in a buffer that is a partial region of the work memory 204. The securing of the buffer and the storing of the streaming data are realized by a function implemented in the OS.

In step S508, the control unit 201 (OS) starts decoding and displaying the streaming data from the point in time at which it is determined that the timing at which playback can be performed has arrived. The timing determination, the decoding, and the GUI for displaying a moving image are realized by a function implemented in the OS. Note that the GUI for displaying a moving image may be displayed in a screen of a communication application using a function of the OS, or an application for playback may be started up separately. Thereafter, the control unit 201 (OS) repeatedly executes the operations in steps S507 and S508 until the moving image data is played back to the end or a suspend instruction is input.

In this way, the PTP is expanded such that the smartphone 200 (playback side device) and the digital camera 100 (output side device) can obtain information (URL or playlist) for specifying the playback target moving image file using the PTP communication therebetween. Also, the digital camera 100 (output side device) manages moving image data in association with the information (streaming information) used when the playback side device requests playback such as a URL or a playlist, and the server function is implemented therein. Therefore, in the case where the OS does not support the streaming playback by PTP, the streaming playback using the function of the OS can be performed, and the function to be implemented to the PTP communication application can be reduced. Note that the streaming information can be systematically generated, and therefore it is not necessary that each image file is provided therewith in advance.

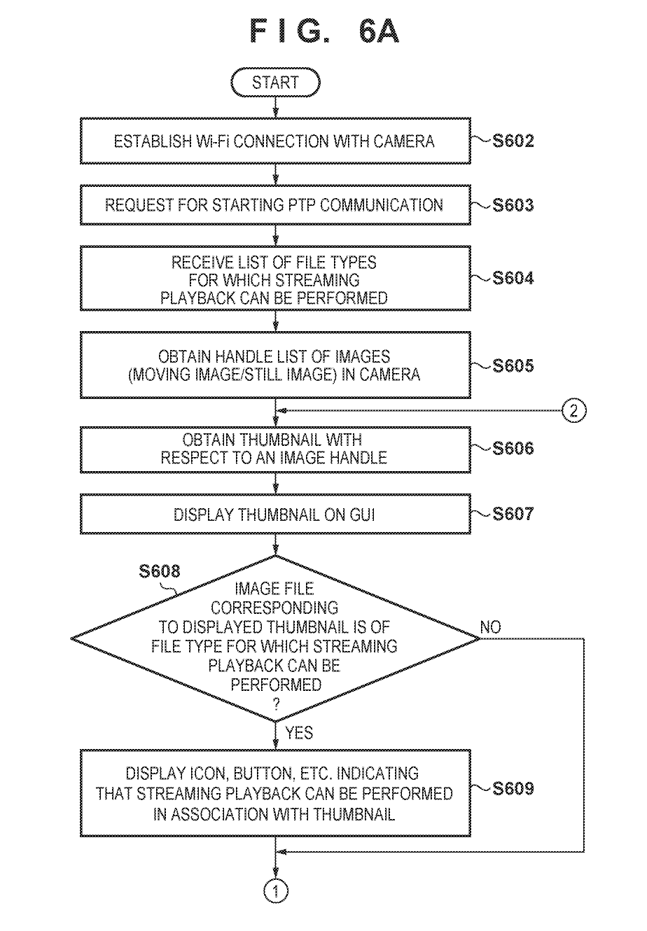

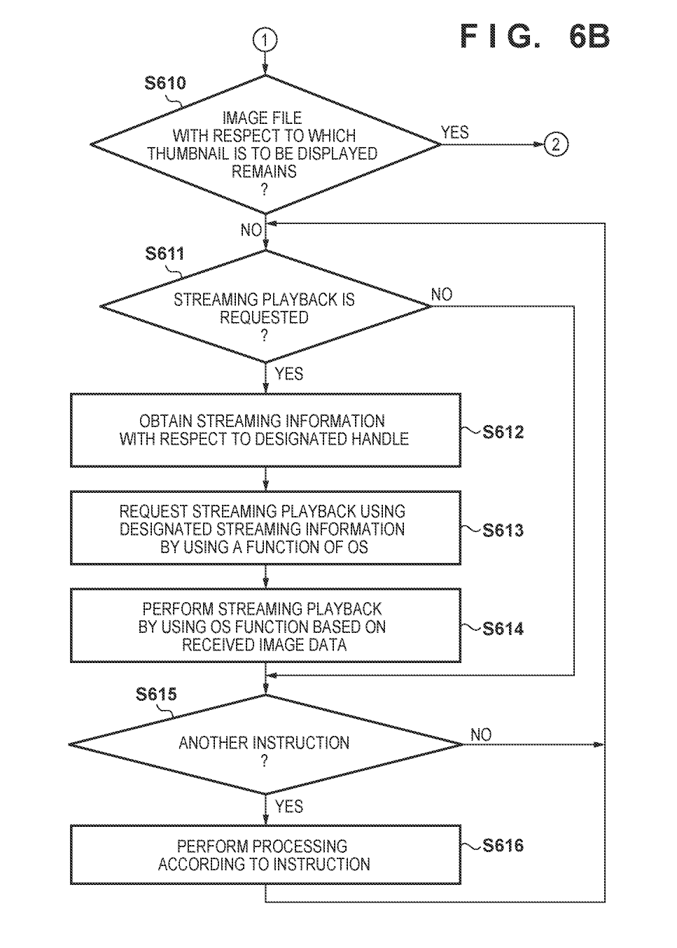

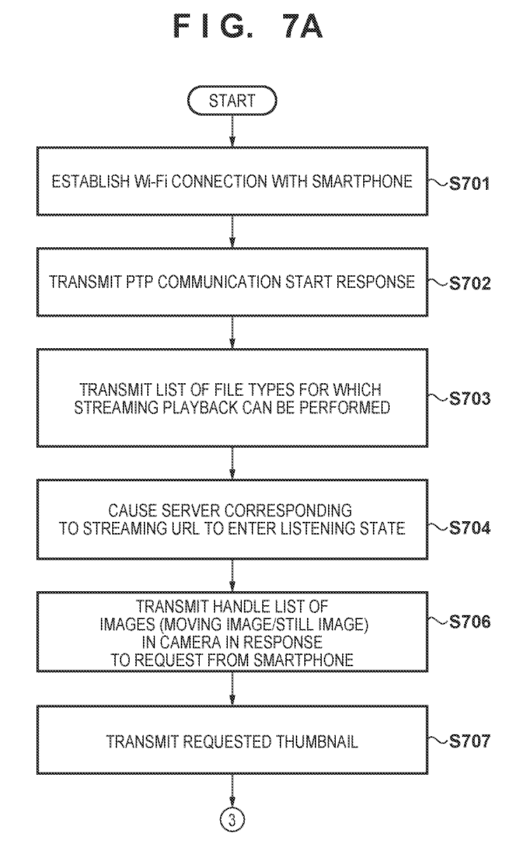

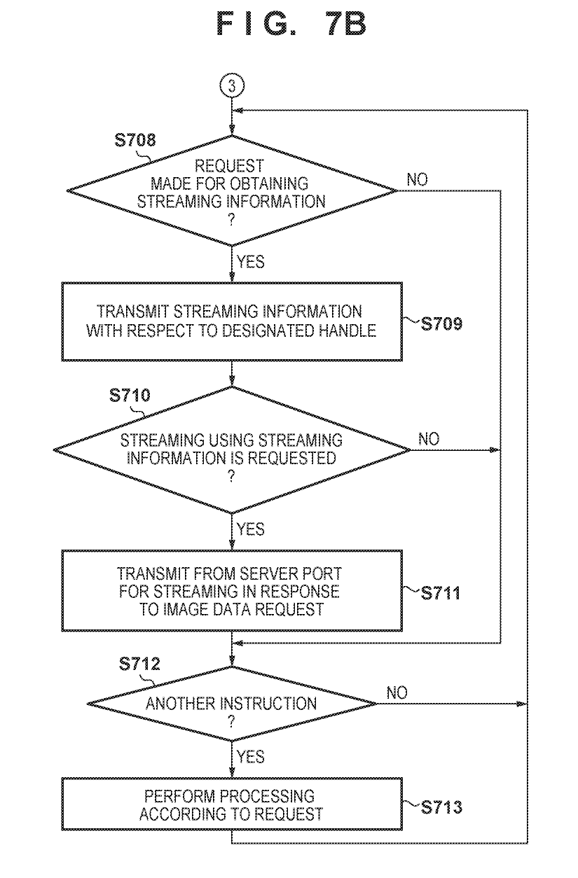

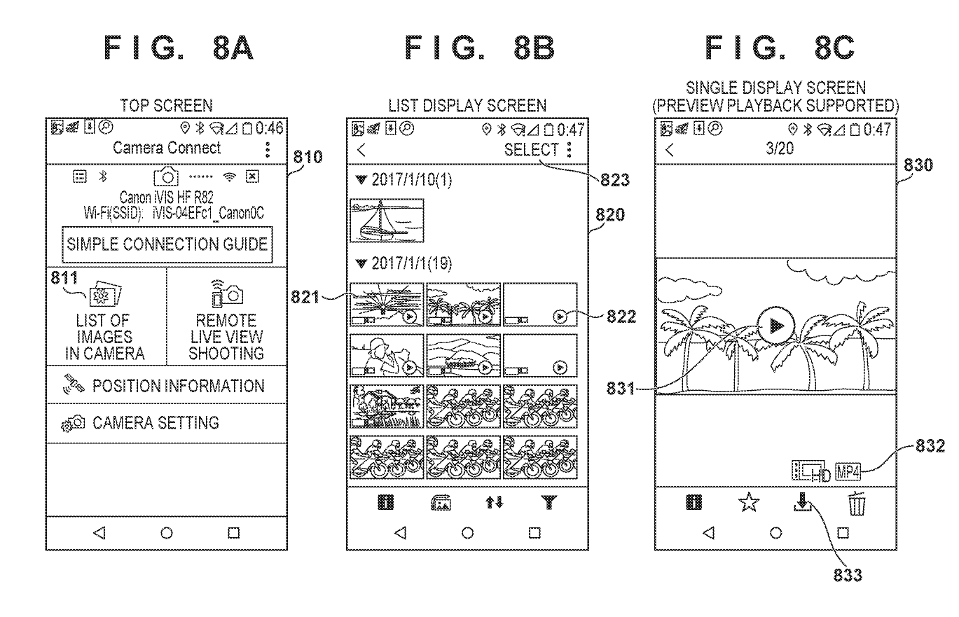

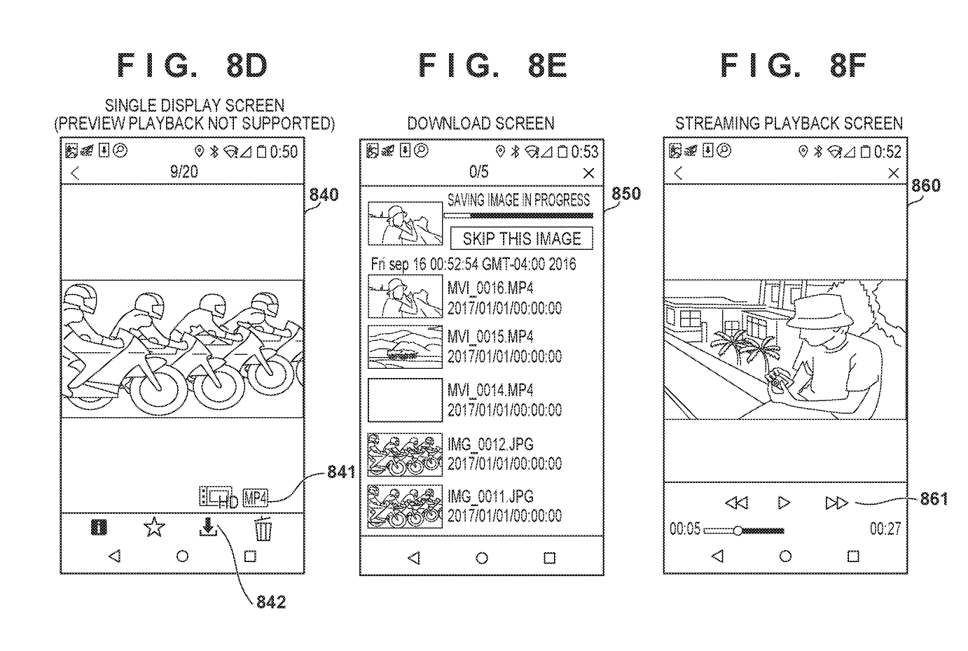

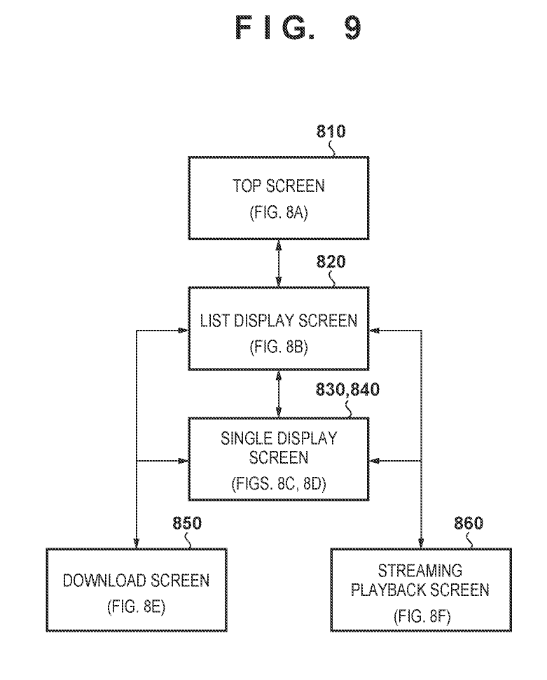

Next, the operations of the smartphone 200 and the digital camera 100 described in FIG. 5 will be further specifically described using FIGS. 6A to 9 in addition to FIG. 5. FIGS. 6A and 6B are flowcharts relating to the operations of the smartphone 200 (control unit 201), and FIGS. 7A and 7B are flowcharts relating to the operations of the digital camera 100 (control unit 101). Also, FIGS. 8A to 9 are diagrams relating to the screen display of the PTP communication application that runs on the smartphone 200.

First, wireless connection (wireless LAN connection, here) is established between the digital camera 100 and the smartphone 200 (step S602, step S701). The procedure of establishing the wireless connection therebetween is not specifically limited. For example, when a mode is set in which the digital camera 100 communicates with an external device, the communication unit 111 starts operating as a simplified AP. When an image transfer application serving as the PTP communication application is started up in the smartphone 200, the smartphone 200 participates in the network formed by the digital camera 100, and the wireless connection may be established. Alternatively, wireless LAN connection may be automatically established by a so-called hand over to the wireless LAN in which the information for the wireless LAN connection is delivered using short-range wireless communication such as NFC (Near Field Communication) or Bluetooth (registered trademark). When the image transfer application is started up, the control unit 201 displays a top screen 810 such as that shown in FIG. 8A in the display unit 206, for example.

In step S603, the control unit 201 (image transfer application (hereinafter, simply referred to as application)) transmits a request to start the PTP communication (OpenSession) to the communication unit 111 of the digital camera 100 via the communication unit 211. In response to this, the control unit 101 transmits a start response (step S702) to the communication unit 211 via the communication unit 111, and the PTP session is established. In actuality, the control unit 201 transmits a request for information of the digital camera 100 (GetDeviceInfo) to the digital camera 100 before transmitting the request for starting PTP communication, and the control unit 101 responds with device information (DeviceInfo Dataset). Note that, in the following, a description of the communication that is needed in the PTP session, but does not directly relate to the operations of the embodiment, will be omitted.

In step S604, the control unit 201 (application) requests a list of the file types for which streaming playback can be performed to the communication unit 111 of the digital camera 100 via the communication unit 211 using the PTP communication. In response to this, the control unit 101 reads out a list of the file types for which streaming playback can be performed that is stored in the nonvolatile memory 203, and transmits the list to the communication unit 211 via the communication unit 111 (step S703). The list of file types may be a list of file extensions, for example, or may include more detailed information. The control unit 201 stores the received list to the work memory 204.

Note that the control unit 101 of the digital camera 100, upon the PTP session being established, enables a server function for streaming playback (HTTP server, for example), and causes a port for streaming to enter a state of listening (step S704). Accordingly, the control unit 101 can accept a request for streaming playback at any time. Here, for the sake of convenience, this processing is described as being executed immediately after transmitting the list of file types for which the streaming playback can be performed to the smartphone 200, but the processing can be executed at any timing before receiving a request for streaming from the smartphone 200.

In step S605, the control unit 201 (application) transmits a request for information of a data file stored in the recording medium 110 of the digital camera 100 to the communication unit 111 of the digital camera 100 via the communication unit 211. Specifically, the control unit 201 transmits a request for a handle list (GetObjectHandles). In PTP, image files in a recording medium are managed according to a DCF file system, and are respectively assigned with object handles unique to the individual directories and image files, as described above. The control unit 101, upon receiving the request for a handle list, transmits an object handle list (ObjectHandleArray) to the smartphone 200 via the communication unit 111 (S706).

The control unit 201, as a result of obtaining the handle list, can request an operation to a specific image file in the recording medium 110 of the digital camera 100. Also the control unit 201 can discriminate the moving image files between those of accepting the streaming playback and those of not accepting the streaming playback from the information of the file types for which the streaming can be performed and that is obtained in step S604 and the handle list. The control unit 201 stores the obtained handle list in the work memory 204.

Steps S606 to S610 are processes in which the control unit 201 (application) obtains thumbnails of respective image files existed in the recording medium 110 from the digital camera 100, and displays the thumbnails in the display unit 206 in a selectable manner. This processing is executed in response to an icon “Image list in camera” 811 being operated (tapped, for example) in the top screen in FIG. 8A, for example. When the icon 811 is operated, the control unit 201 switches the screen of the application to a list display screen 820 (FIG. 8B).

In step S606, the control unit 201 (application) obtains file information and a thumbnail from the digital camera 100 by designating the object handle corresponding to one image file with reference to the handle list. In actuality, the control unit 201 separately transmits a request for information of the file (GetObjectInfo) and a request for the thumbnail (GetThumb) to the digital camera 100. In response to this, the control unit 101 responds to the individual requests with respective requested pieces of information (ObjectInfo and ThumbnailObject) (step S707). The thumbnail recorded in an image file stored in the recording medium 110 is read out, or the thumbnail is generated by the control unit 101 from the image file.

In step S607, the control unit 201 (application) displays the obtained thumbnail 721 in a list display screen 820 of the application.

In step S608, the control unit 201 (application) determines whether or not the thumbnail displayed in step S607 corresponds to moving image data of the file format for which the streaming playback can be performed, and the processing is advanced to step S609 if determined as corresponding thereto, or to step S610 if not. Specifically, the control unit 201 advances the processing to step S609 if the image file corresponding to the thumbnail comes under the file formats for which the streaming can be performed and that is obtained in step S604, and to step S610 if not.

In step S609, the control unit 201 (application) displays a GUI part (a playback icon, for example) 822 for giving instruction for preview playback in association with the displayed thumbnail (FIG. 8B). Note that, in addition to the GUI part for playback instruction, a display (such as a mark or an icon) 821 indicating that preview playback can be performed for the moving image file may be displayed in association with the thumbnail. Here, “displaying in association with the thumbnail” includes not only displaying in a manner in which at least a portion is superimposed on the thumbnail, but also displaying in the vicinity of the thumbnail. Also, a display (a line connected to the thumbnail, for example) indicating a correspondence relation may be separately included.

Note that, a thumbnail (excluding the playback icon portion) is operated without a selection icon 823 being operated in the list display screen 820, the control unit 201 switches the display screen to a single display screen (FIG. 8C or FIG. 8D) in which the operated thumbnail is displayed in an enlarged manner. Note that, if the operated thumbnail corresponds to a moving image file for which preview playback can be performed, the control unit 201 switches the display screen to a single display screen (FIG. 8C) in which a GUI part (a playback icon, for example) 831 for playback instruction is included. Also, if the operated thumbnail corresponds to a moving image file for which preview playback cannot be performed, or corresponds to a still image file, the control unit 201 switches the display screen to a single display screen (FIG. 8D) in which the GUI part 831 for playback instruction is not included. When the selection icon 823 included in the list display screen 820 is operated, an operation on the thumbnail is regarded as a selection operation, and a plurality of thumbnails can be selected. For example, if an operation is not performed in a given time period, for example, the control unit 201 switches the display screen to a download screen (FIG. 8E) for downloading image files corresponding to the thumbnails selected at that time.

The single display screen includes a download icon 833 or 842 and an icon 832 or 841 indicating the size and format of a moving image if the displayed thumbnail corresponds to a moving image file. When the download icon 833 or 842 is operated, the control unit 201 transmits a request for obtaining the corresponding image file (GetObject) to the digital camera 100 via the communication unit 211, and switches the display to a download screen 850 (FIG. 8E). The control unit 101 transmits the requested image file to the smartphone 200 via the communication unit 111. The control unit 201 displays the progress of download in the download screen 850 while recording the received image file in the recording medium 210.

In step S610, the control unit 201 (application) determines whether or not an image file with respect to which a thumbnail is to be displayed remains in the image files included in the handle list stored in the work memory 204, and returns the processing to step S606 if an image file is determined as remaining. The control unit 201 advances the processing to step S611 if no image file with respect to which a thumbnail is to be displayed remains.

The control unit 201 of the smartphone 200 waits to receive an input of an instruction (step S611, step S615), advances the processing to step S612 if an instruction for preview playback is input, and if another instruction is input, executes the processing corresponding to the instruction (step S616) and returns the processing to step S611. The input of the instruction for preview playback may be an operation made to the playback icon 822 or 831 included in the list display screen 820 (FIG. 8B) or in the single display screen 830 (FIG. 8C). Note that the instruction for preview playback does not necessarily need a user operation, and may be generated according to an application, an internal event of the smartphone 200, or the like.

In step S612, the control unit 201 (application) transmits a request for streaming information in which the object handle of an image file corresponding to the thumbnail on which preview playback was instructed is designated to the digital camera 100 via the communication unit 211. This request can be defined as a user expansion instruction (Vendor-Extended Operation Code) of PTP, for example.

The control unit 101 of the digital camera 100 waits to receive a request (step S708, step S712), and advances the processing to step S709 if a request for streaming information is received, and if another request is received, the control unit 101 executes processing corresponding to the received request (step S713), and returns the processing to step S708.

In step S709, the control unit 101 generates streaming information corresponding to the image file associated with the object handle designated in the request, or reads out the streaming information from the recording medium 110. Then, the control unit 101 transmits the streaming information to the smartphone 200 via the communication unit 111. Here, the streaming information is information used for requesting streaming of an image file to a streaming server that runs on the digital camera 100, and may have a format that is different according to the protocol used for the streaming. For example, in the case of using HLS (HTTP Live Streaming), the streaming information is the URL of an index file (playlist) in m3u8 format, and in the case of using HTML5, the streaming information is the URL of a moving image file. Note that the streaming information is not limited to the URL, and may have a format corresponding to the streaming playback function that the OS of the smartphone 200 supports.

Note that, in the case where the generation rule of the streaming information and the IP address of a server are known on the smartphone 200 (application) side, the control unit 201 may generate the streaming information in step S612, instead of transmitting a request for streaming information. The control unit 201 (application) stores the streaming information received from the digital camera 100 (or generated by the control unit 201) in the work memory 204.

In step S613, the control unit 201 (application) delivers the streaming information obtained in step S612 to the OS in order to execute streaming playback of the moving image file on which preview playback was instructed, using a function of the OS.

The control unit 201 (streaming client of OS), upon being notified of the URL with respect to which streaming playback is to be performed from the PTP communication application, transmits a request for streaming to the server of the digital camera 100 via the communication unit 211. The streaming client executes downloading of the designated file, buffering, determination of timing at which playback is possible, decoding, and the like.

The control unit 101 (streaming server) listens to the port for streaming (step S710), and advances the processing to step S711 if a request for streaming has been received, and to step S712 if a request for streaming has not been received. Note that the URL may be generated by the smartphone 200 as described above, and therefore the URL in the received request is not necessarily the URL transmitted in step S709.

In step S711, the control unit 101 (streaming server) transmits segments of the image data stored in the recording medium 110 to the port for streaming via the communication unit 111 in the order according to the request from the control unit 201 of the smartphone 200.

In step S614, the control unit 201 (streaming client of OS) performs streaming playback based on the segments of the image data received via the communication unit 211. FIG. 8F shows an example of the streaming playback screen of the HTTP client application. The screen includes a GUI part 861 for instructing playback/stop, fast forward, rewind, and the like. Note that the GUI for playing back the streaming may be displayed in a predetermined region in an application GUI designated by the PTP communication application, or an application for playback may be separately started up.

The control unit 201 (streaming client of OS), while performing streaming playback, executes the processing in step S615 and onward, and, upon receiving an instruction from the user, executes operations according to the instruction.

Note that the implementation may be such that streaming information is transmitted (step S709) before responding to the request for starting PTP communication (step S702), but it is possible to define in the nonvolatile memory 103 that such implementation will not be performed from the viewpoint of security. Also, when the PTP session is disconnected or the wireless connection is disconnected during the streaming playback, the streaming playback is also stopped.

Exemplary transitions of the screens in FIGS. 8A to 8F described above are shown in FIG. 9. Note that the screen transition shown here is merely an example, and the screen transition is not limited to the illustrated transition relationship.

Note that the case where an icon indicating a still image file is selected in the screen of FIG. 8B is a specific example of the processing in steps S616 and S713. In this case, the control unit 201 (application) transmits a request for obtaining an object of PTP (GetObject) to the digital camera 100, and obtains the still image file. The same applies to the case where a moving image file is obtained in a form of file transmission. That is, in the present embodiment, HTTP is used in the case of streaming playback, but PTP is used for file transmission.

In this way, according to the present embodiment, the user of the smartphone 200 can grasp the moving image files with respect to which preview playback can be performed from the list display of image files that the digital camera 100 has. Also, whether or not a moving image file with respect to which preview playback can be performed will be downloaded can be determined after confirming the contents. Also, the digital camera 100 is implemented with a streaming server function, and information for using a streaming playback function in the second protocol that the OS supports can be obtained using the first protocol used for file transfer. Therefore, the functions to be implemented in the image transfer application that runs on the smartphone 200 in order to realize streaming playback can be substantially reduced.

Note that, in the example described above, the smartphone 200 includes steps (step S604, step S703) for obtaining file formats for which streaming can be performed from the digital camera 100. However, these steps are not essential. For example, the image transfer application may include a correspondence table between model names of the digital camera and the file formats for which streaming can be performed. In this case, the file formats for which streaming can be performed can be known from the model name included in the information (DeviceInfo Dataset) of the digital camera 100 that is obtained when the PTP connection is established. Also, the information as to whether or not streaming can be performed may be included in the information of an individual image file.

The same applies to the streaming information such as URL. The implementation is such that the streaming information is generated on the image transfer application side as described above, or the streaming information may be included in the information of an individual image file.

Also, the communication with the protocol used for streaming is independent of the PTP communication, and therefore the communication can be established at any timing. The communication may be established when streaming playback becomes necessary, or the communication may be established before starting the PTP session. In the streaming using http/https, in general, it is possible that access from IP addresses of an unspecified number can be permitted, and therefore cases where the digital camera and the smartphone are connected in a manner of one-to-many, many-to-one, or many-to-many can be handled as well. In the case of performing peer-to-peer communication, as in the case of the present embodiment, the IP address of the partner of communication can be limited in order for securing security.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-229188, filed on Nov. 25, 2016, which is hereby incorporated by reference herein in its entirety.

What is claimed is:

1. An image provision apparatus comprising:
a communication interface; and
a processor that controls communication with an external device via the communication interface,
wherein the processor
transmits, in response to a request for image data that is received from an external device, the image data to the external device, the request for the image data being in compliance with a first protocol,
transmits, in response to a request for information relating to streaming of the image data that is received from the external device, the information relating to streaming to the external device, the request for the information relating to streaming of the image data being in compliance with the first protocol, and
performs, in response to a request for streaming based on the transmitted information relating to streaming that is received from the external device, streaming of the image data to the external device, the request for the streaming being in compliance with a second protocol.

2. The image provision apparatus according to claim 1, wherein the information relating to streaming is a URL (Uniform Resource Locator) corresponding to an image file designated by the external device.

3. The image provision apparatus according to claim 1, wherein the image provision apparatus is an image capture apparatus.

4. The image provision apparatus according to claim 1, wherein the first protocol is PTP (Picture Transfer Protocol), and the second protocol is HTTP (Hypertext Transfer Protocol).

5. An image reception apparatus comprising:
a communication interface; and
a processor that controls communication with an external device via the communication interface,
wherein the processor
obtains information relating to image files that an external device has from the external device through communication with the external device, the communication being in compliance with a first protocol,
obtains, in compliance with the first protocol, information relating to streaming of a moving image file, among the image files, from the external device,
transmits a request for streaming with respect to the moving image file based on the obtained information relating to streaming to the external device in compliance with a second protocol, using a function provided by an operating system running on the image reception apparatus, and
performs playback on image data from the external device that is received in compliance with the second protocol, using a function provided by the operating system.

6. The image reception apparatus according to claim 5,
wherein the processor
displays information relating to image files that the external device has, in a selectable manner,
if an image file corresponding to information selected is a moving image file in a predetermined format, transmits a request for streaming with respect to the moving image file to the external device, and
if an image file corresponding to the information selected is not a moving image file in the predetermined format, does not transmit the request for streaming with respect to the moving image file to the external device.

7. The image reception apparatus according to claim 6,
wherein the processor
obtains from the external device, in compliance with the first protocol, information regarding file formats for which the external device can perform streaming, and
if the format of an image file corresponding to the information selected is a file format for which the external device can perform streaming, transmits a request for streaming with respect to the image file to the external device.

8. The image reception apparatus according to claim 6, wherein the processor, if an image file corresponding to the selected information is a still image file, obtains the image file from the external device in compliance with the first protocol.

9. The image reception apparatus according to claim 6, wherein the first protocol is PTP (Picture Transfer Protocol), and the second protocol is HTTP (Hypertext Transfer Protocol).

10. An image communication system comprising:
an image provision apparatus; and
an image reception apparatus,
wherein the image provision apparatus and the image reception apparatus are connected in a communicable manner,
wherein the image provision apparatus comprises:
a first communication interface; and
a first processor that controls communication with an external device via the first communication interface,
wherein the first processor
transmits, in response to a request for image data that is received from an image reception apparatus, the image data to the image reception apparatus, the request for the image data being in compliance with a first protocol,
transmits, in response to a request for information relating to streaming of the image data that is received from the image reception apparatus, the information relating to streaming to the image reception apparatus, the request for the information relating to streaming of the image data being in compliance with the first protocol, and
performs, in response to a request for streaming based on the transmitted information relating to streaming that is received from the image reception apparatus, streaming of the image data to the image reception apparatus, the request for the streaming being in compliance with a second protocol, and
wherein the image reception apparatus comprises:
a second communication interface; and
a second processor that controls communication with an external device via the second communication interface,
wherein the second processor
obtains information relating to image files that an image provision apparatus has from the image provision apparatus through communication with the image provision apparatus, the communication being in compliance with a first protocol,
obtains, in compliance with the first protocol, information relating to streaming of a moving image file, among the image files, from the image provision apparatus,
transmits a request for streaming with respect to the moving image file based on the obtained information relating to streaming to the image provision apparatus in compliance with a second protocol, using a function provided by an operating system running on the image reception apparatus, and
performs playback on image data from the image provision apparatus that is received in compliance with the second protocol, using a function provided by the operating system.

11. A control method of an image provision apparatus, comprising:
transmitting, in response to a request for image data that is received from an external device, the image data to the external device, the request for the image data being in compliance with a first protocol,
transmitting, in response to a request for information relating to streaming of the image data that is received from the external device, the information relating to streaming to the external device, the request for the information relating to streaming of the image data being in compliance with the first protocol, and
performing, in response to a request for streaming based on the transmitted information relating to streaming that is received from the external device, streaming of the image data to the external device, the request for the streaming being in compliance with a second protocol.

12. A control method of an image reception apparatus comprising:
obtaining information relating to image files that an external device has from the external device through communication with the external device, the communication being in compliance with a first protocol,
obtaining, in compliance with the first protocol, information relating to streaming of a moving image file, among the image files, from the external device,
transmitting a request for streaming with respect to the moving image file based on the obtained information relating to streaming to the external device in compliance with a second protocol using a function provided by an operating system running on the image reception apparatus, and
performing playback on image data from the external device that is received in compliance with the second protocol, using a function provided by the operating system.

13. A non-transitory computer-readable storage medium that stores a program for causing a computer to function as an image provision apparatus that comprises:
a communication interface; and
a processor that controls communication with an external device via the communication interface,
wherein the processor
transmits, in response to a request for image data that is received from an external device, the image data to the external device, the request for the image data being in compliance with a first protocol,
transmits, in response to a request for information relating to streaming of the image data that is received from the external device, the information relating to streaming to the external device, the request for the information relating to streaming of the image data being in compliance with the first protocol, and
performs, in response to a request for streaming based on the transmitted information relating to streaming that is received from the external device, streaming of the image data to the external device, the request for the streaming being in compliance with a second protocol.

14. A non-transitory computer-readable storage medium that stores a program for causing a computer to function as an image reception apparatus that comprises:
a communication interface; and
a processor that controls communication with an external device via the communication interface,
wherein the processor
obtains information relating to image files that an external device has from the external device through communication with the external device, the communication being in compliance with a first protocol,
obtains, in compliance with the first protocol, information relating to streaming of a moving image file, among the image files, from the external device,
transmits a request for streaming with respect to the moving image file based on the obtained information relating to streaming to the external device in compliance with a second protocol, using a function provided by an operating system running on the image reception apparatus, and
performs playback on image data from the external device that is received in compliance with the second protocol, using a function provided by the operating system.
